(19) United States
(12) Patent Application Publication
(10) Pub. No.: US 2015/0086247 A1
(43) Pub. Date: Mar. 26, 2015

(54) DEVELOPING DEVICE AND IMAGE FORMING APPARATUS

(71) Applicant: SHARP KABUSHIKI KAISHA, Osaka (JP)

(72) Inventor: Yuhsuke YOSHIMOTO, Osaka (JP)

(73) Assignee: SHARP KABUSHIKI KAISHA, Osaka (JP)

(21) Appl. No.: 14/207,837

(22) Filed: Mar. 13, 2014

(30) Foreign Application Priority Data
Sep. 25, 2013 (JP) 2013-198733

(51) Int. Cl. G03G 15/09

(52) U.S. Cl. CPC G03G 15/0921
USPC 399/277

(57) ABSTRACT

There are provided a developing device capable of preventing occurrence of image unevenness by releasing a developer residing on a surface of a developing roller reliably, and an image forming apparatus. An angle α formed by a first plane including a position at which a magnetic flux density in a normal direction by a removing pole becomes a maximal value on a surface of the developing sleeve and a rotational axis of a developing sleeve, and a second plane including a first axis of a first rotational shaft section of a first agitating conveyance section and the rotational axis of the developing sleeve 17 is 20° or more and 40° or less.

### CROSS-REFERENCE TO RELATED APPLICATION

This application claims priority to Japanese Patent Application No. 2013-198733, which was filed on Sep. 25, 2013, the contents of which are incorporated herein by reference in its entirety.

### BACKGROUND OF THE TECHNOLOGY

1. Field of the Technology

The present technology relates to a developing device that develops an electrostatic latent image formed on a photoreceptor using a two-component developer composed of a toner and a carrier, and an image forming apparatus.

2. Description of the Related Art

An electrophotographic image forming apparatus that forms an image by an electrophotographic process is used as an electrostatic copier, a laser beam printer, or the like. The electrophotographic image forming apparatus is provided with a developing device for developing an electrostatic latent image formed on an image bearing member such as a photoreceptor. As a developing system, a two-component developing system that performs development using a two-component developer including a toner and a carrier (hereinafter, simply also referred to as a developer) has been known.

In the two-component developing system, the carrier and the toner are agitated and frictionally charged with each other, so that the toner is carried on a surface of the carrier. On a surface of a sleeve incorporating a magnet, the carrier carrying the toner is formed in a protruding shape called a bristle. The toner included in the bristle that is on the sleeve moves to the electrostatic latent image on the photoreceptor, thereby developing the electrostatic latent image.

After the development, a developer that is deteriorated or that has charging defects has not been developed and resides on the sleeve. When the residual developer is left as it is, the residual developer is provided for the development again, thus causing occurrence of image unevenness or the like.

A developing device described in Japanese Unexamined Patent Publication JP-A 2012-108466 is provided with a supplying screw for supplying a developer to a developing roll and a receiving screw for collecting the developer after development. A developer collecting conveyance path in which the developer collected by the receiving screw is conveyed and a developer supplying conveyance path in which the developer supplied to the developing roll by the supplying screw is conveyed are partitioned by a partition wall, but the two conveyance paths are communicated with each other through openings at both ends of the respective conveyance paths. The developer conveyed by the receiving screw moves to the developer supplying conveyance path through one of the openings and the developer conveyed by the supplying screw moves to the developer collecting conveyance path through the other of the openings.

However, it is difficult to block movement of the developer between the two conveyance paths only by providing the partition wall, and the developer residing on a surface of the developing roller is to be provided for development beyond the partition wall, thus causing image unevenness.

### SUMMARY OF THE TECHNOLOGY

An object of the technology is to provide a developing device capable of preventing occurrence of image unevenness by releasing a developer residing on a surface of a developing roller reliably, and an image forming apparatus.

The technology provides a developing device, comprising:

a developing roller having a cylindrical-shaped sleeve supported so as to be rotatable around an axis thereof and a magnet roller provided with a plurality of magnetic poles that are fixed in the cylindrical-shaped sleeve, the developing roller carrying a two-component developer including a toner and a carrier on a surface of the cylindrical-shaped sleeve to convey the two-component developer to a developing area facing a photoreceptor on which an electrostatic latent image is formed, the plurality of magnetic poles including a developing magnetic pole for supplying the toner to the photoreceptor in the developing area and a removing pole disposed on a downstream side from the developing area in a rotational direction of the cylindrical-shaped sleeve, for removing the two-component developer residing on the surface of the cylindrical-shaped sleeve after the toner is supplied to the photoreceptor from the surface of the cylindrical-shaped sleeve;

a developer supplying member that is disposed vertically below the developing roller and supplies the two-component developer to the surface of the cylindrical-shaped sleeve on an upstream side from the developing area in the rotational direction of the cylindrical-shaped sleeve;

a collecting conveyance member that is disposed on the downstream side from the developing area in the rotational direction of the cylindrical-shaped sleeve and conveys the two-component developer removed from the surface of the cylindrical-shaped sleeve by the removing pole, the collecting conveyance member having a first rotational shaft section extending along a first axis parallel to a rotational axis of the cylindrical-shaped sleeve and a first spiral blade section attached in a spiral form to the first rotational shaft section, the collecting conveyance member conveying the two-component developer along the first axis by the first spiral blade section when the first rotational shaft section rotates around the first axis; and

a movement regulating member that is disposed on a downstream side from the developer collecting conveyance member in the rotational direction of the cylindrical-shaped sleeve and on an upstream side from the developer supplying member in the rotational direction of the cylindrical-shaped sleeve, and regulates movement of the two-component developer residing on the surface of the cylindrical-shaped sleeve,

an angle α formed by a first plane including a position at which a magnetic flux density in a normal direction by the removing pole becomes a maximal value on the surface of the cylindrical-shaped sleeve and the rotational axis of the cylindrical-shaped sleeve, and a second plane including the first axis of the first rotational shaft section and the rotational axis of the cylindrical-shaped sleeve being 20° or more and 40° or less.

An angle α formed by a first plane including a position at which a magnetic flux density in a normal direction by the removing pole becomes a maximal value on the surface of the cylindrical-shaped sleeve and the rotational axis of the cylindrical-shaped sleeve, and a second plane including the first axis of the first rotational shaft section and the rotational axis of the cylindrical-shaped sleeve is 20° or more and 40° or less.

A part of a surface layer of the two-component developer conveyed by the collecting conveyance member is attracted to the removing pole by a magnetic force, and the two-component developer collected by the collecting conveyance member is to be supplied to the removing pole again. When the part of the surface layer of the two-component developer is attracted to the removing pole, an overall height of the two-component developer conveyed by the collecting conveyance member becomes low and the two-component developer existing near the movement regulating member is reduced. Thereby, it is possible to secure a space near the upstream side in the rotational direction of the cylindrical-shaped sleeve at the movement regulating member and to release the two-component developer on the surface of the developing roller to the secured space at a released position, thus making it possible to reduce the amount of the two-component developer beyond the movement regulating member. Accordingly, it is possible to prevent occurrence of image unevenness of a formed image.

Moreover, it is preferable that the maximal value of the magnetic flux density in the normal direction by the removing pole is 30 mT or more and 50 mT or less.

Moreover, the maximal value of the magnetic flux density in the normal direction by the removing pole is 30 mT or more and 50 mT or less. With such a range, the two-component developer collected by the collecting conveyance member is supplied to the removing pole again, and then released from the developing roller.

Moreover, it is preferable that the plurality of magnetic poles further include a scooping pole for scooping up the two-component developer to the surface of the cylindrical-shaped sleeve from the developer supplying member, and

a minimal value of the magnetic flux density in a normal direction between the removing pole and the scooping pole on the surface of the cylindrical-shaped sleeve is 0 mT or more and 10 mT or less.

Moreover, a minimal value of the magnetic flux density in a normal direction between the removing pole and the scooping pole on the surface of the cylindrical-shaped sleeve is 0 mT or more and 10 mT or less. With such a range, the two-component developer that is supplied again to the removing pole among the two-component developer collected by the collecting conveyance member is released as appropriate before the scooping pole.

Moreover, it is preferable that the developer supplying member has a second rotational shaft section extending along a second axis parallel to the rotational axis of the cylindrical-shaped sleeve and a second spiral blade section attached in a spiral form to the second rotational shaft section, and conveys the two-component developer along the second axis by the second spiral blade section when the second rotational shaft section rotates around the second axis, and

the first rotational shaft section is disposed above the second rotational shaft section.

Moreover, the collecting conveyance member and the developer supplying member have such a positional relation that the first rotational shaft section is disposed above the second rotational shaft section, and in the case of such a positional relation, the advantageous effects of the technology are further exerted.

Moreover, the technology provides an image forming apparatus comprising the developing device described above.

Moreover, when an image forming apparatus is provided with the developing device described above, it is possible to form a high-quality image that has no image unevenness.

### BRIEF DESCRIPTION OF THE DRAWINGS

Other and further objects, features, and advantages of the technology will be more explicit from the following detailed description taken with reference to the drawings wherein:

FIG. 1 is a cross-sectional view showing a simplified configuration of a developing device according to an embodiment;

FIG. 2 is a view showing magnetic poles of a magnet roller and distribution of magnetic flux density; and

FIG. 3 is a cross-sectional view showing a simplified configuration of an image forming apparatus provided with the developing device shown in FIG. 1.

### DETAILED DESCRIPTION

Now referring to the drawings, preferred embodiments are described below.

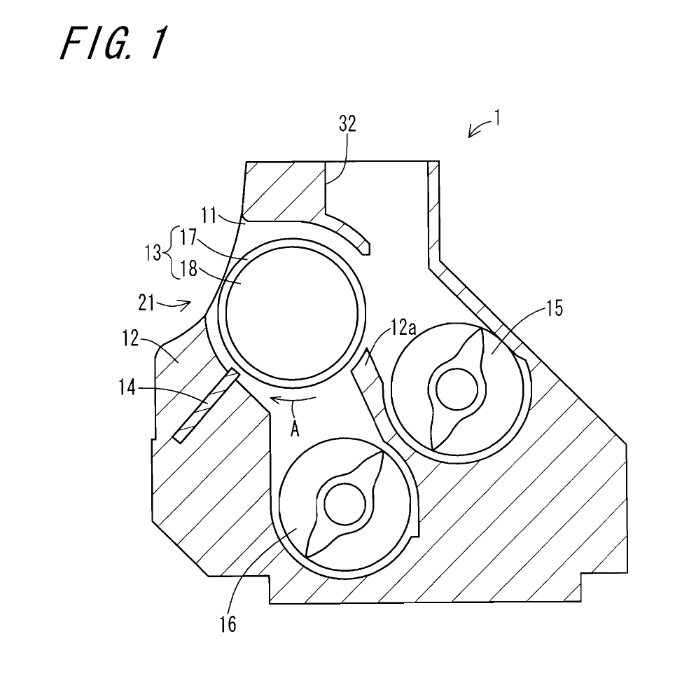

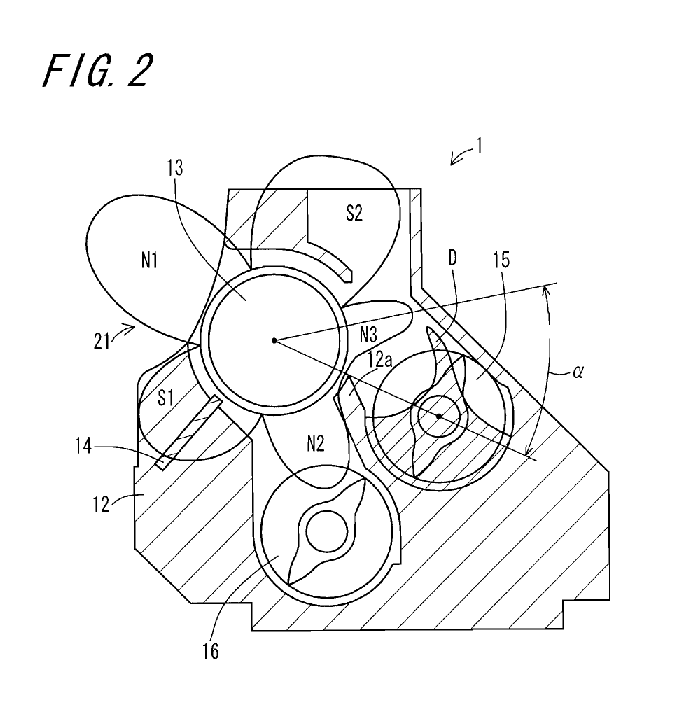

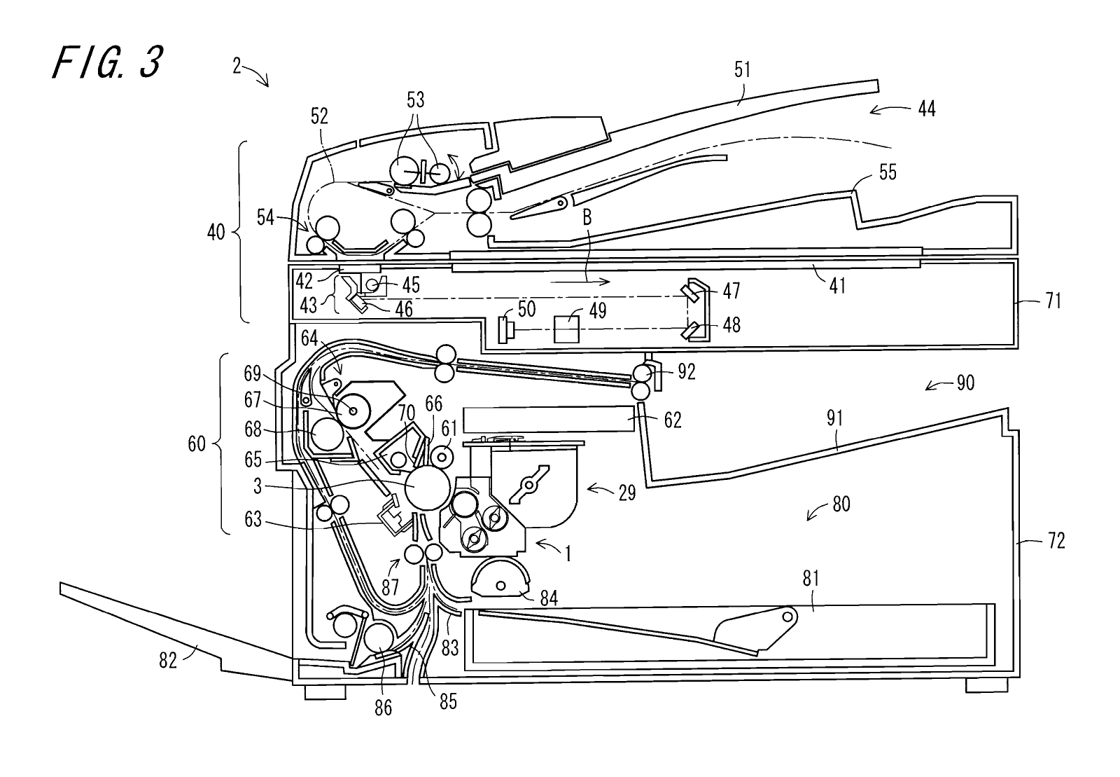

FIG. 1 is a cross-sectional view showing a simplified configuration of a developing device 1 according to an embodiment. FIG. 2 is a view showing magnetic poles of a magnet roller 18 and distribution of magnetic flux density. FIG. 3 is a cross-sectional view showing a simplified configuration of an image forming apparatus 2 provided with the developing device 1 shown in FIG. 1.

The developing device 1 is mounted in the image forming apparatus 2, for example, shown in FIG. 3, and is used for developing an electrostatic latent image formed on an electrophotographic photoreceptor (hereinafter, simply also referred to as a “photoreceptor”) 3 that is an image bearing member to form a toner image. The developing device 1 includes a developer storing container 12, a developing roller 13 that is a developer supplying section, a developer amount regulating member 14, a first agitating conveyance member 15, and a second agitating conveyance member 16. The developer storing container 12 has an opening section 11 that is opened facing the photoreceptor 3 that is the image bearing member, for example, shown in FIG. 3, and a two-component developer including a toner and a carrier (hereinafter, simply also referred to as a “developer”) is stored therein. The developing roller 13 is disposed so as to be opposed to the photoreceptor 3 through an opening of the opening section 11 of the developer storing container 12 inside the developer storing container 12, and supplies the toner in the two-component developer to the photoreceptor 3. The developer amount regulating member 14 is disposed so as to be opposed to the developing roller 13. The first agitating conveyance member 15 collects the developer residing on the surface of the developing roller 13 after development, and conveys the collected developer while mixing and agitating with a toner replenished from a toner hopper 29. The second agitating conveyance member 16 is disposed so as to be rotatable inside the developer storing container 12, and agitates the two-component developer in the developer storing container 12 while conveying to supply the developer to the developing roller 13. In this embodiment, the developer is configured by a nonmagnetic toner and a magnetic carrier.

The developing roller 13 includes a developing sleeve 17 that is disposed opposite to the photoreceptor 3 and is supported so as to be rotatable around an axis thereof, the developing sleeve 17 carrying the two-component developer, and a magnet roller 18 that is disposed so as to be incorporated in the developing sleeve 17 in a fixed manner, the magnet roller 18 generating a magnetic field by a plurality of magnetic poles. In this embodiment, the developing sleeve 17 is driven to rotate in a direction indicated by an arrow A clockwise toward a sheet surface of FIG. 1 by a driving section (not shown). To the developing sleeve 17, a potential is applied from a power source (not shown) so as to cause a potential difference from the photoreceptor 3.

The developing sleeve 17 has a hollow cylindrical shape in this embodiment. A size of an external diameter of the developing sleeve 17 is, for example, 25 mm. The developing sleeve 17 is made of a nonmagnetic material such as aluminum, an aluminum alloy, and stainless steel. An example of the aluminum alloy includes an aluminum (Al)-manganese (Mn) alloy. In this embodiment, a surface section on the outer side in a radial direction that is an outer peripheral surface section of the developing sleeve 17 is subjected to surface roughening processing. An example of the surface roughening processing includes mechanical processing such as sand blast processing. A ten-point average roughness Rz of the outer peripheral surface section of the developing sleeve 17 is not particularly limited and is 5 μm or more and 12 μm or less in this embodiment. The ten-point average roughness Rz refers to a value measured with a measuring reference length as 2.5 mm and an evaluation length as 10 mm according to the Japanese Industrial Standard (JIS) B0601-1982 using a surface roughness measuring instrument, SURFCORDER SE-30H (product name, manufactured by Kosaka Laboratory Ltd.)

Specifically, the magnet roller 18 is disposed on an inner side in the radial direction of the developing sleeve 17, is a substantially cylindrical member, and is coaxially supported by a rotational axis of the developing sleeve 17. The magnet roller 18 is not rotatable like the developing sleeve 17 but is fixed.

The developing roller 13 magnetically attracts the carrier with a magnetic force of the magnet roller 18, and forms a bristle of the developer called a magnetic brush composed of the carrier and the toner on the surface section on the outer side in the radial direction that is the outer peripheral surface section of the developing sleeve 17. The magnetic brush is formed along a magnetic field created by the magnet roller 18. The developing roller 13 causes the developing sleeve 17 to rotate in the direction indicated by the arrow A to thereby convey the developer to a developing area 21 that is a region where the developing roller 13 and the photoreceptor 3 are opposed to each other most proximately.

Specifically, the developer amount regulating member 14 is disposed so as to be opposed to the developing sleeve 17. The developer amount regulating member 14 regulates the amount of the two-component developer carried by the developing sleeve 17 with a gap between its free end and the surface of the developing sleeve 17.

The developer amount regulating member 14 is made of a nonmagnetic material. By making the developer amount regulating member 14 of the nonmagnetic material, it is possible to prevent a regulating section 14a from being magnetized and to prevent the carrier from being adhered to the regulating section 14a.

The first agitating conveyance member 15 is disposed on the downstream side from the developing area in the rotational direction of the developing sleeve 17, and collects the two-component developer removed from the surface of the developing sleeve 17 with a removing pole of the magnet roller 18 and conveys the collected developer while mixing and agitating with the toner replenished from the toner hopper 29. The first agitating conveyance member 15 is a collecting conveyance member that has a first rotational shaft section extending along a first axis parallel to the rotational axis of the developing sleeve 17 and a first spiral blade section that is attached in a spiral form to the first rotational shaft section. The first rotational shaft section rotates around the first axis to thereby convey the two-component developer along the first axis in one direction by the first spiral blade section.

The second agitating conveyance member 16 is a developer supplying member that is disposed vertically below the developing roller 13 and agitates the two-component developer in the developer storing container 12 as well as supplies the two-component developer to the surface of the developing sleeve 17 on the upstream side from the developing area in the rotational direction of the developing sleeve 17. The second agitating conveyance member 16 has a second rotational shaft section extending along a second axis parallel to the rotational axis of the developing sleeve 17 and a second spiral blade section that is attached in a spiral form to this second rotational shaft section. The second rotational shaft section rotates around the second axis to thereby convey the two-component developer along the second axis in another direction by the second spiral blade section.

The first agitating conveyance member 15 and the second agitating conveyance member 16 have such a positional relation that the first agitating conveyance member 15 is disposed on the upstream side from the second agitating conveyance member 16 in the rotational direction of the developing sleeve 17, and the first agitating conveyance member 15 is above the second agitating conveyance member 16, in other words, the first rotational shaft section of the first agitating conveyance member 15 is disposed above the second rotational shaft section of the second agitating conveyance member 16.

The first agitating conveyance member 15 and the second agitating conveyance member 16 have a conveyance space communicating, for example, at both ends of each conveyance direction, respectively, in which the two-component developer is conveyed with the circulation between the first agitating conveyance member 15 and the second agitating conveyance member 16. The first agitating conveyance member 15 agitates the two-component developer after development and a toner that is newly replenished while conveying, and the two-component developer that has been agitated sufficiently is conveyed by the second agitating conveyance member 16 and supplied to the developing roller 13. Accordingly, a partition wall 12a that is a movement regulating member for regulating movement of the two-component developer from the first agitating conveyance member 15 to the second agitating conveyance member 16 is disposed between the first agitating conveyance member 15 and the second agitating conveyance member 16 so that the two-component developer is conveyed by the first agitating conveyance member 15 so as not to be mixed in the second agitating conveyance member 16 before being conveyed to an end portion of the first agitating conveyance member 15. In this embodiment, the partition wall 12a is constituted by a part of the developer storing container 12, and a tip end thereof is in proximity to the surface of the developing sleeve 17 to regulate movement from the first agitating conveyance member 15 to the second agitating conveyance member 16. The partition wall 12a has a thickness of, for example, 2 to 5 mm, and a gap between the tip end of the partition wall 12a and the surface of the developing sleeve 17 is, for example, 0.5 to 2 mm.

As shown in FIG. 2, the magnet roller 18 in this embodiment has five magnetic poles of a developing main pole N1, a scooping pole N2, a removing pole N3, a conveying pole S1 and a collecting pole S2. The developing main pole N1, the scooping pole N2 and the removing pole N3 are magnetic poles having an N pole, and the conveying pole S1 and the collecting pole S2 are magnetic poles having an S pole. The five magnetic poles are disposed in the order of the developing main pole N1, the conveying pole S1, the scooping pole N2, the removing pole N3 and the collecting pole S2 from the downstream side to the upstream side in the rotational direction of the developing sleeve 17. The developing main pole N1 is disposed at a position facing the photoreceptor 3. The conveying pole S1 is disposed on the upstream side from the developing main pole N1 in the rotational direction of the developing sleeve 17 and is at a position facing the developer amount regulating member 14. The scooping pole N2 is disposed at a position facing the first agitating conveyance member 15, and scoops up the two-component developer conveyed by the first agitating conveyance member 15 with a magnetic force to supply the two-component developer from the first agitating conveyance member 15 to the surface of the developing sleeve 17.

The collecting pole S2 is disposed on the downstream side from the developing area in the rotational direction of the developing sleeve 17, and holds the two-component developer residing on the surface of the developing sleeve 17 after the toner is supplied to the photoreceptor 3 by the position of the removing pole N3 facing the second agitating conveyance member 16.

The removing pole N3 is disposed on the downstream side from the developing area in the rotational direction of the developing sleeve 17, is disposed at a position facing the second agitating conveyance member 16, and removes the two-component developer residing on the surface of the developing sleeve 17 after the toner is supplied to the photoreceptor 3 from the surface of the developing sleeve 17 with a magnetic force.

FIG. 2 is a view showing distribution of the magnetic flux density in a normal direction of an outer peripheral surface of the developing sleeve 17. In the technology, arrangement of each magnetic pole is shown with the position at which the magnetic flux density becomes a maximal value in the distribution of the magnetic flux density in the normal direction of the outer peripheral surface of the developing sleeve 17. The magnetic flux density in the normal direction of the outer peripheral surface of the developing sleeve 17 refers to a component in the normal direction when the magnetic flux density caused by magnetic poles is resolved into a component in the normal direction for the outer peripheral surface of the developing sleeve 17 and a component in the tangential direction for the outer peripheral surface of the developing sleeve 17.

The position of each magnetic pole is able to be shown with a rotational angle in the case of setting the position at which the magnetic flux density in the normal direction of the outer peripheral surface of the developing sleeve 17 by the developing main pole N1 becomes the maximal value (hereinafter, simply referred to as the “position”) to 0° and setting the direction toward the downstream side in the rotational direction of the developing sleeve 17 with the position of the rotational axis of the developing sleeve 17 as a center to positive (+) (hereinafter, also referred to as “the rotational angle from the developing main pole N1”). Note that, the rotational angle shown in FIG. 2 is an example and the technology is not limited by this.

In this embodiment, each magnetic pole of the magnet roller 18 is disposed at intervals of predetermined rotational angles from the developing main pole N1 in a peripheral direction of the developing sleeve 17 as shown in FIG. 2. Specifically, the conveying pole S1 is disposed at a position where the rotational angle from the developing main pole N1 becomes 286°. The scooping pole N2 is disposed at a position where the rotational angle from the developing main pole N1 becomes 220°. The removing pole N3 is disposed at a position where the rotational angle from the developing main pole N1 becomes 140°. The collecting pole S2 is disposed at a position where the rotational angle from the developing main pole N1 becomes 80°.

The peripheral direction shown in FIG. 2 shows the rotational angle in the case of setting the position of the developing main pole N1 to 0° and setting the direction toward the downstream side in the rotational direction of the developing sleeve 17 with the position of the rotational axis of the developing sleeve 17 as a center to positive (+), and a radiation direction (radial direction) shows a magnitude of the magnetic flux density.

The position of each magnetic pole is as described above, and description will be given below for an example of the magnitude of the magnetic flux density at each position of the magnetic pole (maximal value of the component in the normal direction). The magnitude of the magnetic flux density of the developing main pole N1 is 115 mT, the magnitude of the magnetic flux density of the scooping pole N2 is 63 mT, and the magnitude of the magnetic flux density of the removing pole N3 is 42 mT. Moreover, the magnitude of the magnetic flux density of the conveying pole S1 is 73 mT and the magnitude of the magnetic flux density of the collecting pole S2 is 83 mT.

The residual developer subjected to a magnetic force in the direction of being removed from the surface of the developing sleeve 17 by the removing pole N3 is released from the developing roller 13 and collected by the first agitating conveyance member 15. This released position is near the partition wall 12a between the first agitating conveyance member 15 and the second agitating conveyance member 16, and when the amount of the two-component developer conveyed by the first agitating conveyance member 15 is relatively large, a lot of two-component developers exits also near the partition wall 12a, so that there is a case where the two-component developer residing after development is not released from the developing roller 13. The two-component developer that has not been released from the developing roller 13 passes through a slight gap between the partition wall 12a and the surface of the developing sleeve 17 to reach the second agitating conveyance member 16. Then, development is carried out again despite the existence of the two-component developer that has not been developed and is residing on the surface of the developing sleeve 17.

The technology is made focusing on a positional relation between the removing pole N3 and the first agitating conveyance member 15 in order to release the two-component developer residing on the developing roller 13 without being developed at the original released position so as to be collected by the first agitating conveyance member 15. Specifically, an angle α formed by a first plane including a position at which the magnetic flux density in the normal direction by the removing pole N3 becomes the maximal value and the rotational axis of the developing sleeve 17 and a second plane including the first axis of the first rotational shaft section of the first agitating conveyance member 15 and the rotational axis of the developing sleeve 17 is 20° or more and 40° or less.

With such an angle range, a part of a surface layer of a two-component developer D being conveyed by the first agitating conveyance member 15 is attracted to the removing pole N3 by a magnetic force, and the two-component developer collected by the first agitating conveyance member 15 is to be supplied to the removing pole N3 again. When the part of the surface layer of the two-component developer D is attracted to the removing pole N3, an overall height of the two-component developer D conveyed by the first agitating conveyance member 15 becomes low and the two-component developer D existing near the partition wall 12a is reduced. Thereby, it is possible to secure a space near the upstream side in the rotational direction of the developing sleeve 17 at the partition wall 12a and to release the two-component developer on the surface of the developing roller 13 to the secured space at a released position, thus making it possible to reduce the amount of the two-component developer beyond the partition wall 12a. Accordingly, it is possible to prevent occurrence of image unevenness of a formed image.

Since the position of the removing pole N3 becomes closer to the partition wall 12a when the angle α is smaller than 20°, even when a part of the surface layer of the two-component developer D being conveyed by the first agitating conveyance member 15 is attracted to the removing pole N3 by a magnetic force, it is impossible to secure a sufficient space at the partition wall 12a and to release the two-component developer residing on the developing roller 13. Further, when a is larger than 40°, even when the two-component developer released from the developing roller 13 to be collected is agitated with a toner newly replenished by the first agitating conveyance member 15, the agitated two-component developer is not conveyed to the second agitating conveyance member 16.

The maximal value of the magnetic flux density of the removing pole N3 is preferably 30 mT or more and 50 mT or less. With such a range, the two-component developer collected by the first agitating conveyance member 15 is supplied again to the removing pole N3, and is then released from the developing roller. In the case of being smaller than 30 mT, the two-component developer collected by the first agitating conveyance member 15 is agitated with the newly replenished toner, but becomes difficult to be supplied to the removing pole N3 again. That is, the two-component developer agitated with the newly replenished toner becomes difficult to be conveyed to the second agitating conveyance member 16. In the case of being larger than 50 mT, the two-component developer collected by the first agitating conveyance member 15 is agitated with the newly replenished toner and supplied to the removing pole N3 again, but the two-component developer that is supplied again is not sufficiently removed from the surface of the developing roller 13.

By setting the angle α to be within a predetermined range and securing the space near the upstream side in the rotational direction of the developing sleeve 17 at the partition wall 12a as described above, it is possible to make the two-component developer on the surface of the developing roller 13 released easily, and, further, it is preferable that a minimal value of the magnetic flux density in the normal direction between the removing pole N3 and the scooping pole N2 is set to 0 mT or more and 10 mT or less.

By setting the minimal value of the magnetic flux density between the removing pole N3 and the scooping pole N2 to such a range, the two-component developer that is supplied again to the removing pole N3 among the two-component developer collected by the first agitating conveyance member 15 is released as appropriate before the scooping pole N2. In the case of being larger than 10 mT, a part of the two-component developer that is supplied again is possibly conveyed to the scooping pole N2 without being released form the developing roller 13.

Moreover, as shown in FIG. 3, the developing device 1 is provided with the toner hopper 29 for replenishing the toner to the developer storing container 12. The toner hopper 29 has a hopper main body serving as a hollow container-shaped member similar to the developer storing container 12. The hopper main body has a hopper-side replenishing port section in which a hopper-side replenishing port for replenishing the toner into the developer storing container 12 is formed. The developer storing container 12 is provided with a container-side replenishing port section 32 in which a container-side replenishing port is formed. A space in the developer storing container 12 and a space in the toner Koper 29 communicate with each other through the container-side replenishing port and the hopper-side replenishing port.

The toner hopper 29 replenishes the toner in the hopper main body 30 into the developer storing container 12 through the hopper-side replenishing port and the container-side replenishing port. When the density of the toner in the developer storing container 12 detected by a toner density sensor (not shown) becomes a predetermined reference value or less, the toner hopper 29 is controlled by a control section (not shown) to replenish the toner in the toner hopper 29 into the developer storing container 12.

With the developing device 1 shown in FIG. 1, an electrostatic latent image is developed as follows. First, the developer in the developer storing container 12 is agitated by the first and second agitating conveyance members 15 and 16 to be charged, and conveyed to the position facing the scooping pole N2 of the developing roller 13. The developer conveyed to the position facing the scooping pole N2 is magnetically attracted to the developing sleeve 17 with a magnetic force of the scooping pole N2 to form a magnetic brush composed of the carrier and the toner at the outer peripheral surface section of the developing sleeve 17.

The developer carried by the developing sleeve 17 as the magnetic brush is conveyed to the downstream side in the rotational direction of the developing sleeve 17 with rotation of the developing sleeve 17, and the amount of the developer to be carried by the outer peripheral surface section of the developing sleeve 17 is regulated at the position opposite to the developer amount regulating member 14. Further, the developer is frictionally charged by the developer amount regulating member 14.

The developer that has passed through the position opposed to the developer amount regulating member 14 is conveyed to the developing area 21 in which the developing main pole N1 is formed with rotation of the developing sleeve 17. In the developing area 21, by a potential difference of the developing sleeve 17 and the photoreceptor 3, only the toner is supplied to the photoreceptor 3 from the magnetic brush formed on the outer peripheral surface section of the developing sleeve 17. Thereby, the electrostatic latent image formed on the photoreceptor 3 is developed and a toner image that is a visible image is formed on the surface of the photoreceptor 3.

The developer that has not been transferred to the photoreceptor 3 and resides on the developing sleeve 17 passes through the developing area 21, is conveyed into the developer storing container 12 with a magnetic force of the collecting pole S2, is removed and released from the developing sleeve 17 by the removing pole N3, and is collected by the first agitating conveyance member 15. The collected developer is conveyed while being agitated and mixed by the first agitating conveyance member 15 with the toner replenished from the toner hopper 29, and is moved to the second agitating conveyance member 16 at the end in the conveyance direction. The developer that is agitated and conveyed by the second agitating conveyance member 16 is scooped up again by the scooping pole N2 to be provided for development.

Moreover, the outer peripheral surface of the developing sleeve 17 is preferably subjected to surface roughening processing. With the surface roughening processing, the developing sleeve 17 is able to hold the developer stably. This makes it possible to convey the developer to the developing area 21 stably, thus making it possible to maintain the amount of the developer to be conveyed to the developing area 21 to the amount regulated by the developer amount regulating member and to prevent occurrence of variability in the conveyance amount of the developer. Accordingly, it is possible to prevent occurrence of developing unevenness.

For example, the ten-point average roughness Rz of the outer peripheral surface section of the developing sleeve 17 is set to 5 μm or more and 12 μm or less. By setting the ten-point average roughness Rz of the outer peripheral surface section of the developing sleeve 17 to 12 μm or less, adjustment of the developer amount by the developer amount regulating member 14 becomes easy, thus making it possible to make the conveyance amount of the developer to be a desired value. Moreover, by setting the ten-point average roughness Rz of the outer peripheral surface section of the developing sleeve 17 to 5 μm or more, it is possible to convey the developer to the developing area 21 more stably.

Further, in this embodiment, the developer amount regulating member 14 is disposed so as to regulate the amount of the developer carried by the developing sleeve 17 to 20 mg/cm² or more and 80 mg/cm² or less. By setting the conveyance amount of the developer to the developing area 21 to 80 mg/cm² or less, it is possible to prevent the filling density of the magnetic brush from becoming overly large in the developing area 21 and to prevent an increase in a dynamic friction force due to contact of the photoreceptor 3 and the magnetic brush in the developing area 21. Thereby, it is possible to cause the photoreceptor 3 and the magnetic brush to be in contact with gentle (soft) touch, thus making it possible to prevent occurrence of non-uniform brushing.

Moreover, by setting the conveyance amount of the developer to the developing area 21 to 20 mg/cm² or more, it is possible to prevent the filling density of the magnetic brush from becoming overly small in the developing area 21, thus making it possible to cause the photoreceptor 3 and the magnetic brush to be in contact more reliably. This makes it possible to supply the toner in the magnetic brush to the photoreceptor 3.

Moreover, the developing main pole N1 facing the photoreceptor 3 is set as having the N pole in this embodiment, but without limitation thereto, the developing main pole may have the S pole. In this case, the magnet roller 18 may have the S pole at the position where the N pole is disposed in this embodiment and may have the N pole at the position where the S pole is disposed in this embodiment.

Moreover, in this embodiment, the magnet roller 18 has five magnetic poles, but the number of the magnetic poles included in the magnet roller 18 is not limited thereto. For example, the magnet roller 18 may have seven magnetic poles composed of an N1 pole, an N2 pole, an N3 pole and an N4 pole that are N poles, and an S1 pole, an S2 pole and an S3 pole that are S poles, and the position of the magnetic pole serving as the removing pole among them may be at the position satisfying the angle α as described above.

Next, description will be given for a toner and a carrier constituting a two-component developer. A toner used in the developing device 1 includes a binder resin, a colorant, a wax and a charge control agent.

(Binder Resin)

The binder resin includes a first polyester resin with a weight average molecular weight (Mw) of 4000 or more and 10000 or less (hereinafter, described as a “low-molecular-weight polyester resin”) and a second polyester resin with the weight average molecular weight (Mw) of 50000 or more and 300000 or less (hereinafter, described as a “high-molecular-weight polyester resin”). When the binder resin includes the low-molecular-weight polyester resin, it is possible to enhance low-temperature fixability of the toner. Further, when the binder resin includes the high-molecular-weight polyester resin, it is possible to enhance anti-high temperature offset property and durability of the toner.

The high-molecular-weight polyester resin and the low-molecular-weight polyester resin are able to be obtained by polycondensing an alcohol component and a carboxylic acid component that are raw material monomers in the presence of a titanium-based catalyst.

Examples of the alcohol component include a divalent alcohol component and trivalent or higher-valent alcohol component.

Examples of the divalent alcohol component include: alkylene oxide adducts of bisphenol A such as polyoxypropylene(2.2)-2,2-bis(4-hydroxyphenyl)propane, polyoxypropylene(3.3)-2,2-bis(4-hydroxyphenyl)propane, polyoxyethylene(2.0)-2,2-bis(4-hydroxyphenyl)propane, polyoxypropylene(2.0)-polyoxyethylene(2.0)-2,2-bis(4-hydroxyphenyl)propane, and polyoxypropylene(6)-2,2-bis(4-hydroxyphenyl)propane; ethylene glycol; diethylene glycol; triethylene glycol; 1,2-propylene glycol; 1,3-propylene glycol; 1,4-butanediol; neopentyl glycol; 1,4-butenediol; 1,5-pentanediol; 1,6-hexanediol; 1,4-cyclohexane dimethanol; dipropylene glycol; polyethylene glycol; polypropylene glycol; polytetramethylene glycol; bisphenol A; a propylene adduct of bisphenol A; an ethylene adduct of bisphenol A; and hydrogenated bisphenol A.

Examples of the trivalent or higher-valent alcohol component include: sorbitol; 1,2,3,6-hexanetetrol; 1,4-sorbitan; pentaerythritol; dipentaerythritol; tripentaerythritol; 1,2,4-butanetriol; 1,2,5-pentanetriol; glycerol; 2-methylpropanetriol; 2-methyl-1,2,4-butanetriol; trimethylolethane; trimethylolpropane; and 1,3,5-trihydroxymethylbenzene.

Examples of the acid component include a divalent carboxylic acid component and a trivalent or higher-valent carboxylic acid component.

Examples of the divalent carboxylic acid component include: maleic acid; fumaric acid; citraconic acid; itaconic acid; glutaconic acid; phthalic acid; isophthalic acid; terephthalic acid; succinic acid; adipic acid; sebacic acid; azelaic acid; malonic acid; n-dodecenyl succinic acid; isododecenyl succinic acid; n-dodecyl succinic acid; isododecyl succinic acid; n-octenyl succinic acid; n-octyl succinic acid; isooctenyl succinic acid; isooctyl succinic acid; and anhydrides of such acids or lower alkyl esters thereof.

Examples of the trivalent or higher-valent carboxylic acid component include: 1,2,4-benzene tricarboxylic acid; 2,5,7-naphthalene tricarboxylic acid; 1,2,4-napthalene tricarboxylic acid; 1,2,4-butane tricarboxylic acid; 1,2,5-hexane tricarboxylic acid; 1,3-dicarboxyl-2-methyl-2-methylene carboxy propane; 1,2,4-cyclohexane tricarboxylic acid; tetra methylene carboxyl methane; 1,2,7,8-octane tetracarboxylic acid; pyromellitic acid; EMPOL trimer acid; anhydrides of such acids; and lower alkyl esters thereof.

Among them, in particular, 1,2,4-benzene tricarboxylic acid, that is, trimellitic acid or a derivative thereof is inexpensive and provides easy reaction control, and therefore preferably used.

As described above, the weight average molecular weight (Mw) of the low-molecular-weight polyester resin is 4000 or more and 10000 or less. When the weight average molecular weight of the low-molecular-weight polyester resin is less than 4000, preservation property of the toner is decreased. When the weight average molecular weight of the low-molecular-weight polyester resin exceeds 10000, low-temperature fixability is decreased.

The low-molecular-weight polyester resin is preferably a polyester resin composed of a linear main chain or a polyester resin having a structure composed of a linear main chain and a relatively short side chain that is bonded thereto, and is preferably obtained by polycondensation of the divalent monomer component without using the trivalent or higher-valent monomer component and a cross-linking agent.

The low-molecular-weight polyester resin does not include tetrahydrofuran (hereinafter, described as “THF”) insoluble component and has a number average molecular weight (Mn) of 4000 or more and 10000 or less.

A ratio of the weight average molecular weight to the number average molecular weight (Mw/Mn) of the low-molecular-weight polyester resin is preferably 2 or more and 10 or less.

An acid value of the low-molecular-weight polyester resin is preferably 40 mgKOH/g or less, and more preferably 10 mgKOH/g or more and 30 mgKOH/g or less. When the acid value of the low-molecular-weight polyester resin exceeds 40 mgKOH/g, charging property of the toner is possibly decreased under a high humidity environment.

A softening point of the low-molecular-weight polyester resin is preferably 80° C. or more and 120° C. or less, and more preferably 90° C. or more and 110° C. or less. When the softening point of the low-molecular-weight polyester resin is less than 80° C., a cohesive power of the low-molecular-weight polyester resin is extremely decreased. When the softening point of the low-molecular-weight polyester resin exceeds 120° C., low-temperature fixability of the toner is decreased.

A glass transition temperature of the low-molecular-weight polyester resin is preferably 50° C. or more and 75° C. or less, and more preferably 50° C. or more and 65° C. or less.

As described above, the weight average molecular weight (Mw) of the high-molecular-weight polyester resin is 50000 or more and 300000 or less, and preferably 150000 or more and 250000 or less. When the weight average molecular weight of the high-molecular-weight polyester resin is less than 50000, durability and anti-high temperature offset property of the toner are decreased. When the weight average molecular weight of the high-molecular-weight polyester resin exceeds 300000, dispersibility of the wax is decreased in the binder resin.

The high-molecular-weight polyester resin is preferably a polyester resin obtained by polycondensation of the divalent monomer component and the trivalent or higher-valent monomer component. Moreover, the high-molecular-weight polyester resin preferably includes a cross-linking component. When the high-molecular-weight polyester resin includes a cross-linking component, it is possible to enhance durability of the toner.

The high-molecular-weight polyester resin has the THF insoluble component of less than 3% by weight, and has the number average molecular weight (Mn) of 6000 or more and 12000 or less, and preferably 8000 or more and 10000 or less.

A ratio of the weight average molecular weight to the number average molecular weight (Mw/Mn) of the high-molecular-weight polyester resin is 30 or less, and preferably 15 or more and 25 or less. The Mw/Mn shows broadening of a molecular weight distribution of the high-molecular-weight polyester resin. When the Mw/Mn exceeds

, the high-molecular-weight polyester resin contains a low-molecular-weight component and a high-molecular-weight component, thus decreasing durability of the toner and dispersibility of the wax.

An acid value of the high-molecular-weight polyester resin is preferably 50 mgKOH/g or less, and more preferably 15 mgKOH/g or more and 45 mgKOH/g or less. When the acid value of the high-molecular-weight polyester resin exceeds 50 mgKOH/g, charging property of the toner is possibly decreased under a high humidity environment.

A softening point of the high-molecular-weight polyester resin is preferably 110° C. or more and 160° C. or less, and more preferably 120° C. or more and 150° C. or less. When the softening point of the high-molecular-weight polyester resin is less than 110° C., a cohesive power of a resin is extremely decreased. When the softening point of the high-molecular-weight polyester resin exceeds 160° C., melting fluidity and low-temperature fixability of the toner using the resin are decreased.

A glass transition temperature of the high-molecular-weight polyester resin is preferably 50° C. or more and 75° C. or less, and more preferably 55° C. or more and 70° C. or less.

In this embodiment, a titanium-based catalyst is used as a catalyst in the case of polymerizing the low-molecular-weight polyester resin and the high-molecular-weight polyester resin.

Examples of the titanium-based catalyst include at least one of titanium compounds consisting of a titanium alkoxide compound having an alkoxy group with a carbon number of 1 to 8, titanium aliphatic carboxylate with a carbon number of 1 to 32, titanium aromatic carboxylate with a carbon number of 7 to 38, titanyl aliphatic carboxylate with a carbon number of 1 to 32, titanyl aromatic carboxylate with a carbon number of 7 to 38, titanyl carboxylate, and a titanium chelate compound.

Specifically, the raw material monomer above and the titanium-based catalyst above are added, reaction is performed at a reaction temperature of 170 to 250° C. and a reaction pressure of 5 mmHg to a normal pressure (the optimum temperature and pressure are determined by reactivity of the monomer component), and at the time when predetermined physicality described above is obtained, the reaction may be finished. Note that, the raw material monomer above may be added additionally at the time when polycondensation reaction of the raw material monomer above has progressed to some extent. Specifically, the raw material monomer above is subjected to polycondensation for 3 to 5 hours at the temperature of 220 to 250° C., and after cooling to the temperature of 170 to 210° C., the raw material monomer above may be added additionally.

(Colorant)

Examples of the colorant include a yellow toner colorant, a magenta toner colorant, a cyan toner colorant, and a black toner colorant. Hereinafter, a color index is abbreviated as “C.I.”.

Examples of the yellow toner colorant include: pigments such as C.I. Pigment Yellow 1, C.I. Pigment Yellow 5, C.I. Pigment Yellow 12, C.I. Pigment Yellow 15, C.I. Pigment Yellow 17, C.I. Pigment Yellow 180, C.I. Pigment Yellow 93, C.I. Pigment Yellow 74, and C.I. Pigment Yellow 185; inorganic pigments such as yellow iron oxide and yellow ocher; and nitro-based dyes such as C.I. Acid Yellow 1; and oil-soluble dyes such as C.I. Solvent Yellow 2, C.I. Solvent Yellow 6, C.I. Solvent Yellow 14, C.I. Solvent Yellow 15, C.I. Solvent Yellow 19, and C.I. Solvent Yellow 21, which are classified according to the color index.

Examples of the magenta toner colorant include: C.I. Pigment Red 49; C. I. Pigment Red 57; C. I. Pigment Red 81; C. I. Pigment Red 122; C. I. Solvent Red 19; C. I. Solvent Red 49; C. I. Solvent Red 52; C. I. Basic Red 10; and C. I. Disperse Red 15, which are classified according to the color index.

Examples of the cyan toner colorant include: C. I. Pigment Blue 15; C. I. Pigment Blue 16; C. I. Solvent Blue 55; C. I. Solvent Blue 70; C. I. Direct Blue 25; and C. I. Direct Blue 86, which are classified according to the color index.

Examples of the black toner colorant include carbon blacks such as channel black, roller black, disk black, gas furnace black, oil furnace black, thermal black, and acetylene black. The proper carbon black may be selected as appropriate from among these various kinds of carbon blacks according to a target design characteristic of the toner.

Other than these pigments, a bright red pigment, a green pigment, and the like are usable. The colorants may be used each alone, or two or more of them may be used in combination. Further, it is possible to use two or more of the colorants of the same color series and also possible to use one or two or more of the colorants respectively from different color series. Further, two or more of the colorants, even with the same color series, may be used in combination. A colorant content in a melt-kneaded material of toner materials is not particularly limited, and is preferably 0.1 to 20% by weight, and more preferably 0.2 to 10% by weight in a sum of the melt-kneaded material.

(Wax)

As the wax, any of hydrocarbon-based waxes such as paraffin wax, polyethylene wax, polypropylene wax, polyethylene-polypropylene wax and microcrystalline wax; alcohol-modified hydrocarbon wax; ester wax; carnauba wax; amid-based wax and the like is usable, and paraffin wax, ester wax and microcrystalline wax are preferable from a viewpoint of compatibility and releasability with a binder resin and a melting point. The waxes may be used each alone, or two or more of them may be used in combination.

The melting point of the wax is preferably 50° C. or more and 100° C. or less, and more preferably 60° C. or more and 90° C. or less from a viewpoint of ensuring low-temperature fixability of the toner. In the toner of the technology, low-melting wax having such a low melting point is dispersed uniformly in the binder resin including the low-molecular-weight polyester resin and the high-molecular-weight polyester resin, so that low-temperature fixability is excellent.

An acid value of the wax is preferably less than 2.0 mgKOH/g, and more preferably less than 1.0 mgKOH/g. When the acid value of the wax is 2.0 mgKOH/g or more, compatibility with the binder resin is high and oozing at the time of fixation becomes poor, so that it is difficult to enhance low-temperature fixability of the toner.

A hydroxyl value of the wax is preferably less than 5.0 mgKOH/g, and more preferably less than 3.0 mgKOH/g. When the hydroxyl value of the wax is 5.0 mgKOH/g or more, compatibility with the binder resin is high and oozing at the time of fixation becomes poor, so that it is difficult to enhance low-temperature fixability of the toner.

A content of the wax is preferably 0.5 part by weight or more and 10 parts by weight or less, and more preferably 1 part by weight or more and 8 parts by weight or less, relative to 100 parts by weight of the binder resin.

(Charge Control Agent)

As the charge control agent, those which for positive charge control and negative charge control customarily used in the relevant field are usable.

Examples of the charge control agent for positive charge control include: a basic dye; quaternary ammonium salt; quaternary phosphonium salt; aminopyrine; a pyrimidine compound; a polynuclear polyamino compound; aminosilane; a nigrosine dye and a derivative thereof; a triphenylmethane derivative; guanidine salt; and amidine salt. Examples of the charge control agent for negative charge control include: oil-soluble dyes such as oil black and spiron black; a metal-containing azo compound; an azo complex dye; metal naphthenate; a metal compound (the metal is boron, aluminum and the like) of a benzilic acid derivative; metal complex and metal salt (the metal is chrome, zinc, zirconium and the like) of salicylic acid and a derivative thereof; a fatty acid soap; long-chain alkylcarboxylic acid salt, and a resin acid soap. The charge control agents may be used each alone, or two or more of them may be used in combination as necessary.

A content of the charge control agent in a melt-kneaded material of the toner materials is not particularly limited and may be selected as appropriate from a wide range, and is preferably 0.5 to 5% by weight in a sum of the melt-kneaded material.

The toner of the technology may contain, in addition to the binder resin, the colorant, the wax and the charge control agent, additives such as a conductive conditioner, an extender pigment, an antioxidant, a fluidity enhancer and a cleaning property enhancer as appropriate.

(Method for Manufacturing Toner)

The toner of the technology is manufactured, for example, with a melt-kneading method as follows.

The above-mentioned toner materials are dry-mixed in a mixer, the obtained admixture is melt-kneaded with a kneader to obtain a melt-kneaded material. The melt-kneading is performed while heating to the temperature not lower than the melting temperature of the binder resin (normally about 80 to 200° C., and preferably about 100 to 150° C.)

It is preferable that, in the melt-kneaded material, 0.1 to 20% by weight of the colorant and 1 to 10% by weight of the wax are included, and the remains are the binder resin. Alternatively, it is preferable that 0.1 to 20% by weight of the colorant, 1 to 10% by weight of the wax, and 0.5 to 3% by weight of the charge control agent are included, and the remains are the binder resin.

As the mixer, those which are publicly known are usable, and examples thereof include: Henschel type mixing devices such as HENSCHEL MIXER (product name, manufactured by Mitsui Mining Co., Ltd.), SUPERMIXER (product name, manufactured by Kawata Mfg Co., Ltd.), and MECHANOMILL (product name, manufactured by Okada Seiko Co., Ltd.); ANGMILL (product name, manufactured by Hosokawa Micron Corporation); HYBRIDIZATION SYSTEM (product name, manufactured by Nara Machinery Co., Ltd.); and COSMOSYSTEM (product name, manufactured by Kawasaki Heavy Industries, Ltd.)

Also as the kneader, those which are publicly known are usable, and a general kneader such as biaxial extruder, three-roll mill or a laboplast mill is usable. More specifically, examples thereof include a monoaxial or biaxial extruder such as TEM-100B (product name, manufactured by Toshiba Machine Co., Ltd.) or PCM-65/87 (product name, manufactured by Ikegai Corp), and one of the open roll system such as KNEADEX (product name, manufactured by Mitsui Mining Co., Ltd.)

The melt-kneaded material is cooled and solidified to obtain a resin composition. The resin composition is pulverized into a coarsely pulverized material, for example, having a particle size of about 100 μm to 5 mm by a hammer mill, a cutter mill or the like. Then, such a coarsely pulverized material is further pulverized until it becomes fine powders, for example, having a particle size of 15 μm or less. For pulverization of the coarsely pulverized material, for example, a jet pulverizer for performing pulverization utilizing an ultrasonic jet stream, an impact pulverizer for performing pulverization by introducing a coarsely pulverized material into a space formed between a rotator (rotor) rotating at a high speed and a stator (liner), or the like is usable.

After the pulverization by the pulverizer, classification may be performed to remove fine powders from toner particles.

The toner particles manufactured as described above may be directly used as the toner or the toner particles to which an external additive is added may be used as the toner. By adding the external additive, it is possible to obtain effects of enhancement of powder fluidity, enhancement of frictional chargeability, heat resisting property, improvement of long-time storage property, improvement of cleaning characteristic, and control of photoreceptor-surface abrasion characteristic.

Examples of the external additive include fine silica powders, fine titanium oxide powders and fine alumina powders. The external additive may be used each alone, or two or more of them may be used in combination.

As the amount of the external additive to be added, 0.1 part by weight or more and 2 parts by weight or less relative to 100 parts by weight of the toner particles is preferable, in consideration of a charging amount needed for the toner, effects for abrasion of the photoreceptor due to addition of the external additive, environmental characteristic of the toner and the like.

As the carrier, those which are publicly known are usable, and examples thereof include single or complex ferrite composed of iron, copper, zinc, nickel, cobalt, manganese, chromium, or the like; a resin-coated carrier having carrier core particles whose surfaces are coated with coating materials; and a resin-dispersion type carrier in which magnetic particles are dispersed in a resin.

As the coating material, those which are publicly known are usable, and examples thereof include polytetrafluoroethylene, a monochlorotrifluoroethylene polymer, polyvinylidene fluoride, a silicone resin, a polyester resin, a metal compound of di-tertiary-butylsalicylic acid, a styrene resin, an acrylic resin, polyamide, polyvinyl butyral, nigrosine, an aminoacrylate resin, basic dyes, lakes of basic dyes, fine silica powders, and fine alumina powders. Further, the resin used for the resin-dispersion type carrier is not particularly limited, and examples thereof include a styrene-acrylic resin, a polyester resin, a fluorine resin, and a phenol resin. All of them are preferably selected according to the toner components, and may be used each alone, or two or more of them may be used in combination.

The carrier preferably has a spherical shape or a flattened shape. A volume average particle size of the carrier is not particularly limited, and in consideration of higher-quality images, is preferably 10 to 100 μm, and more preferably 20 to 50 μm. In addition, a volume resistivity of the carrier is preferably 10⁸ Ω·cm or more, and more preferably 10¹² Ω·cm or more.

The volume resistivity of the carrier is a value obtained from a current value determined as follows. The carrier particles are put into a container having a cross-sectional area of 0.50 cm², and then tapped. Subsequently, a load of 1 kg/cm² is applied by use of a weight to the particles which are held in the container. When an electric field of 1000 V/cm is generated between the weight and a bottom electrode of the container by application of voltage, a current value is read. When the resistivity of the carrier is low, an electric charge will be injected into the carrier upon application of bias voltage to a developing sleeve, thus causing the carrier particles to be more easily attached to the photoreceptor. Further, breakdown of the bias voltage is more liable to occur.

The saturated magnetization of the carrier is preferably 40 emu/g or more and 80 emu/g or less.

The use ratio of the toner to the carrier in the two-component developer is not particularly limited, and is able to be selected as appropriate according to kinds of the toner and the carrier. For example, in the case of mixing with the resin-coated carrier (density of 5 to 8 g/cm²), the toner may be included by 2 to 30% by weight, and preferably 2 to 20% by weight in a sum of the developer amount. Further, the coverage of the carrier with the toner is preferably 40 to 80%.

Next, description will be given for the image forming apparatus 2 provided with the developing device 1.

As shown in FIG. 3, the image forming apparatus 2 is generally includes a document reading section (hereinafter, also referred to as a “scanner section”) 40, an image forming section 60, a paper feeding section 80, and a paper discharge section 90. The document reading section 40 is disposed vertically above the paper feeding section 80, and the paper discharge section 90 is disposed at a part intermediate between the document reading section 40 and the paper feeding section 80 in the vertical direction. Specifically, the document reading section 40 is disposed in an area spanning an inner side of an upper housing 71 and an upper side of the upper housing 71, the paper feeding section 80 is disposed in a lower part of a lower housing 72, and the paper discharge section 90 is disposed on an upper part of the lower housing 72.

The document reading section 40 includes a first platen glass 41 on which a document is to be placed, a second platen glass 42 to which a document is to be fed from a document feeding section 44, a copy lamp unit 43 that reads image information from the document placed on the first platen glass 41 or the document fed to the second platen glass 42 and outputs the obtained image information to a not-shown image processing section, and the document feeding section 44 that feeds the document to the second platen glass 42. The copy lamp unit 43 is disposed inside the upper housing 71. Moreover, the document feeding section 44 is disposed above the upper housing 71.

The copy lamp unit 43 includes a copy lamp 45 that is a light source, a first mirror 46, second and third mirrors 47 and 48, an optical lens 49, and a CCD image sensor 50. The copy lamp 45 irradiates the document placed on the first platen glass 41 or the document fed to the second platen glass 42 with light. The first mirror 46 deflects a reflected light image from the document in a predetermined direction. The second and third mirrors 47 and 48 sequentially deflect the reflected light image from the document which reflected light image is deflected by the first mirror 46, further in a predetermined direction. The optical lens 49 reduces the reflected light image from the document which reflected light image is deflected by the third mirror 48, to form the reflected light image on the CCD image sensor 50 including a charge couple device (abbreviated as CCD). The CCD image sensor 50 performs photoelectric conversion of the reflected light image from the document which reflected light image is formed by the optical lens 49, and outputs an electric signal to the image processing section.

The document feeding section 44 includes a document tray 51 on which a document is to be placed, a paper feeding roller 53 that feeds the document placed on the document tray 51 to a conveyance path 52, registration rollers 54 that temporarily hold the document fed by the paper feeding roller 53 to feed to the second platen glass 42 with appropriate timing, and a document catch tray 55 to which the document whose image information has been read is discharged.

The image forming section 60 includes a photoreceptor 3 that is an image bearing member disposed so as to be rotatable around an axis thereof, a charging unit 61 that is a charging section, a laser scanner unit 62 that is an exposure section, the developing device 1 shown in FIG. 1 described above that is a developing section, a transfer unit 63 that is a transfer section, a fixing device 64 that is a fixing section, a cleaning unit 65 that is a cleaning section, and a charge removing device 66 that is a charge removing section. The charging unit 61, the laser scanner unit 62, the developing device 1, the transfer unit 63, the cleaning unit 65, and the charge removing device 66 are disposed around the photoreceptor 3 in this order from the upstream side to the downstream side in the rotational direction of the photoreceptor 3. The photoreceptor 3 in this embodiment has a cylindrical column shape. The shape of the photoreceptor 3 is not limited to the cylindrical column shape and may be a cylindrical shape, for example.

As shown in FIG. 2 described above, the developing sleeve 17 of the developing device 1 is disposed opposite to the photoreceptor 3 so as to be rotatable around an axis parallel to a rotational axis of the photoreceptor 3. A distance between the developing sleeve 17 and the photoreceptor 3 is not particularly limited and is 0.25 mm or more and 0.50 mm or less in this embodiment. As described above, the developing device 1 develops an electrostatic latent image formed on an outer peripheral surface section of the photoreceptor 3 by exposure.

The charging unit 61 charges the outer peripheral surface section of the photoreceptor 3. The laser scanner unit 62 exposes the photoreceptor 3 that has been charged. The transfer unit 63 transfers a toner image which is a visible image formed by development, to recording paper that is a recording medium. The transfer unit 63 is realized by, for example, a corona charger. The fixing device 64 fixes the transferred toner image to the recording paper. Specifically, the fixing device 64 includes a heating roller 67 provided with a heating heater 69 thereinside and a pressure roller 68 that elastically abuts against a surface section of the heating roller 67. The cleaning unit 65 includes a cleaning blade 70 and scrapes off and removes, by the cleaning blade 70, the toner residing on the outer peripheral surface section of the photoreceptor 3 after the transfer operation by the transfer unit 63 to clean the outer peripheral surface section of the photoreceptor 3. The charge removing device 66 removes the charge on the outer peripheral surface section of the photoreceptor 3 that has been cleaned by the cleaning unit 65.

The paper feeding section 80 is disposed inside the lower housing 72, and includes a paper feeding cassette 81, a manual tray 82, a first paper feeding roller 84, a second paper feeding roller 86, and registration rollers 87. In the paper feeding cassette 81, recording paper that is a recording medium is stored. The manual tray 82 is protrudingly disposed from a side surface section of the lower housing 72, on which recording paper is placed. The first paper feeding roller 84 feeds the recording paper stored in the paper feeding cassette 81 to a first conveyance path 83. The second paper feeding roller 86 feeds the recoding paper placed on the manual tray 82 to a second conveyance path 85. The registration rollers 87 temporarily hold the recording paper to feed to the image forming section 60 with appropriate timing.

The paper discharge section 90 includes a paper discharge roller 92 that discharges the recording paper to which the toner image has been fixed by the fixing device 64 of the image forming section 60 to a catch tray 91, and the catch tray 91 that stores the recording paper discharged by the paper discharge roller 92.

The image forming apparatus 2 has, as image formation (hereinafter, also referred to as “printing”) modes, a copy mode (hereinafter, also referred to as a “copier mode”), a printer mode and a facsimile mode. In response to operation input from an operation section (not shown) and receipt of a printing job from an external host apparatus such as a personal computer, a corresponding printing mode is selected from among the printing modes described above, by a control section (not shown) described below.

In the case of the copier mode among the printing modes described above, an image is formed as follows. A user places a document on the first platen glass 41 of the document reading section 40, supplies recording paper to the paper feeding cassette 81 or the manual tray 82 of the paper feeding section 80, and further, after inputting the number of printing copies, printing magnification and the like by a condition input key on an operation panel (not shown) that is disposed on the near side, toward a sheet surface of FIG. 3 of the upper housing 71, by operating a start key on the operation panel, copy operation is started.

When the start key is operated, a main driving motor (not shown) commences operations, and each of driving gears (not shown) rotates. Subsequently, the first paper feeding roller 84 or the second paper feeding roller 86 of the paper feeding section 80 rotates, and the recoding paper is conveyed (fed) to the first conveyance path 83 or the second conveyance path 85 and reaches a pair of registration rollers 87 to be caught. The registration rollers 87 cause the recording paper to temporarily stop so as to synchronize timing when a leading end part of the toner image, that is, a part from which image formation begins, that is formed on the surface section of the photoreceptor 3 reaches a position at which the transfer unit 63 is disposed and timing when an area of the recording paper in which image formation is to be performed reaches the position at which the transfer unit 63 is disposed. In addition, at this time, a leading end part of the recording paper is uniformly pressed against the registration rollers 87, and the correction of the position of the leading end part of the recording paper is performed.

Moreover, at the document reading section 40, the copy lamp 45 lights, and when the copy lamp unit 43 starts to move in a direction indicated by an arrow B, exposure of the document is started. Irradiated light from the copy lamp 45 to the document is reflected by the document and becomes reflected light including document image information. This reflected light from the document enters the CCD image sensor 50 by way of the first mirror 46, the second mirror 47, the third mirror 48, and the optical lens 49. Thereby, the document image information is read.

The document image information read as the optical signal in this manner is converted into an electrical signal by a photoelectric conversion section (not shown) in the CCD image sensor 50 and output the converted image information to the image processing section. At the image processing section, the inputted image information is subjected to image processing with set conditions, and the image information subjected to the image processing is transmitted to the laser scanner unit 62 of the image forming section 60 as printing data.

Moreover, at the image forming section 60, a part of the outer peripheral surface section of the photoreceptor 3 is charged to a predetermined potential over the whole of the axial direction of the photoreceptor 3 by the charging unit 61, and further the photoreceptor 3 rotates, so that the whole outer peripheral surface section of the photoreceptor 3 is charged to the predetermined potential. With rotation of the photoreceptor 3, the outer peripheral surface section of the photoreceptor 3 that has been charged is subjected to the following step sequentially.

At the laser scanner unit 62, laser light emitted from semiconductor laser is deflected according to printing data inputted from the image processing section, by a polygonal mirror having a plurality of reflective faces in the rotational direction (rotating multi-faceted mirror) and various optical systems, which are not shown, so that the photoreceptor 3 is irradiated with the deflected laser light. Thereby, the laser light is scanned for the outer peripheral surface section of the photoreceptor 3 that has been charged by the charging unit 61, and an electrostatic latent image is formed on the outer peripheral surface section of the photoreceptor 3.

Then, the toner in the developer stored in the developer storing container 12 is supplied to the outer peripheral surface section of the rotating photoreceptor 3 by the developing roller 13 in the developer storing container 12 of the developing device 1. The toner is adhered to the outer peripheral surface section of the photoreceptor 3 in accordance with a potential gap for forming the electrostatic latent image. Thereby, the electrostatic latent image is made visible (developed) and a toner image is formed.

Moreover, being timed by the registration rollers 87 of the paper feeding section 80, the recording paper on which an image is to be formed is fed to a transfer position between the photoreceptor 3 and the transfer unit 63. At the transfer position, the toner image formed on the outer peripheral surface section of the photoreceptor 3 is transferred to the recording paper by the transfer unit 63.

The recording paper to which the toner image has been transferred is conveyed to the fixing device 64 and applied with heat and pressure when passing between the heating roller 67 and the pressure roller 68 of the fixing device 64. Thereby, the unfixed toner on the surface section of the recording paper fuses to be adhered and fixed to the recording paper. The recording paper to which the toner image has been fixed is discharged to the catch tray 91 by the paper discharge roller 92 of the paper discharge section 90.

Further, the toner that has not been transferred to the recording paper and resides on the outer peripheral surface section of the photoreceptor 3 is scraped off and collected by the cleaning blade 70 of the cleaning unit 65. The charge on the outer peripheral surface section of the photoreceptor 3 from which the residing toner has been scraped off by the cleaning blade 70 is removed by the charge removing device 66 in the process of moving to a position at which the charging unit 61 is disposed. The charge on the outer peripheral surface section of the photoreceptor 3 may not be removed by the charge removing device 66, when it is not necessary to remove the charge.

In the embodiment described above, though image information is read in a state where a document is placed on the first platen glass 41 by a user and remains still, image information may be read in a state where the document is being fed to the second platen glass 42 by the document feeding section 44. In this case, the document is placed on the document tray 51 of the document reading section 40.

In this manner, in a case where the start key is operated when it is detected by a sensor (not shown) that the document is placed on the document tray 51 of the document reading section 40, the paper feeding roller 53 of the document feeding section 44 rotates and the document placed on the document tray 51 is fed to the conveyance path 52. The document fed to the conveyance path 52 is caught by the registration rollers 54 disposed in the conveyance path 52, and after positioning a leading end of the document, is conveyed to a position at which the second platen glass 42 is disposed, that is a document reading position, at predetermined timing. The copy lamp unit 43 exposes the document being conveyed while stopping at a predetermined stopping position that is the document reading position. The reflected light from the document obtained by this exposure is read as a document image as described above. The document whose image information has been read in this manner is discharged to the document catch tray 55.

In the case of the printer mode described above, the document reading section 40 is not activated and an image is formed according to image information inputted from an external host apparatus such as a personal computer. Moreover, in the case of the facsimile mode, an image is formed according to image information inputted through a communication line.

### EXAMPLES

In order to confirm the effects of the technology, examples as follows were examined.

### <Examination of Angle α>

A configuration of a developing device used for examples was the same as the configuration shown in FIG. 1. As to the developing roller 13, an outer diameter was 18 mm and a rotational frequency was 300 rpm. As to the first agitating conveyance member 15, an outer diameter was 16 mm, a screw pitch of the first spiral blade section was 36 mm, and a rotational frequency was 500 rpm. As to the second agitating conveyance member 16, an outer diameter was 16 mm, a screw pitch of the second spiral blade section was 36 mm, and a rotational frequency was 500 rpm. The developer amount was 200 g, thickness of the partition wall 12a was 3 mm, a gap between the partition wall 12a and the surface of the developing sleeve 17 of the developing roller 13 was 1 mm.

The relative positional relation of each magnetic pole of the magnet roller 18 and the maximal value of the magnetic flux density in the normal direction of each magnetic pole are as shown in FIG. 2.

By changing the angle α to 23° (Example 1), 33° (Example 2) and 43° (Comparative Example 1), releasing property, resupplying property, agitating property and circulating property of the developing device were evaluated.

For releasing property, whether a developer is released from the developing roller at a releasing position was evaluated, and for resupplying property, whether the developer agitated and conveyed by the first agitating conveyance member 15 is resupplied to the removing pole N3 sufficiently was evaluated. For agitating property, whether a newly replenished toner is sufficiently agitated by the first agitating conveyance member 15 before conveyed to the second agitating conveyance member 16 was evaluated, and for circulating property, whether the developer is circulated in the developer storing container 12 without bias was evaluated. Results are shown in a table 1.

TABLE 1

| | Releasing | Resupplying | Agitating | Circulating |
|---|---|---|---|---|
| | property | property | Property | property |
| Example 1 | A | A | A | A |
| Example 2 | A | A | A | A |
| Comparative | B | C | B | A |
| Example 1 | | | | |

In Comparative Example 1 in which the angle α was larger than 40°, resupplying of the developer to the removing pole N3 was not made, so that releasing property and agitating property were decreased. Against this, in Examples 1 and 2 in which the angle α fell within a range of 20° or more and 40° or less, resupplying of the developer to the removing pole N3 was made, so that excellent results were obtained also for releasing property and agitating property.

<Examination of Magnetic Flux Density of Removing Pole N3>

As to the developing device for which the angle α has been examined, by setting the angle α to 23° and changing the maximal value of the magnetic flux density in the normal direction of the removing pole N3 to 28 mT (Example 3), 33 mT (Example 4), 48 mT (Example 5) and 53 mT (Example 6), releasing property, resupplying property, agitating property and circulating property of the developing device were evaluated. Results are shown in a table 2.

TABLE 2

| | Releasing | Resupplying | Agitating | Circulating |
|---|---|---|---|---|
| | property | property | property | property |
| Example 3 | A | B | B | A |
| Example 4 | A | A | A | A |
| Example 5 | A | A | A | A |
| Example 6 | B | A | B | A |

In Example 3 in which the maximal value of the magnetic flux density in the normal direction by the removing pole N3 fell out of a range of 30 mT or more and 50 mT or less, resupplying property and agitating property were slightly worse than those of Examples 4 and 5 falling within the above range, and in Example 6 falling out of the above range, releasing property and agitating property were slightly worse than those of Examples 4 and 5.

<Examination of Magnetic Flux Density Between Removing Pole N3 and Scooping Pole N2>

As to the developing device for which the angle α has been examined, by setting the angle α to 23° and the maximal value of the magnetic flux density in the normal direction of the removing pole N3 to 48 mT, and changing a minimal value of the magnetic flux density in the normal direction between the removing pole N3 and the scooping pole N2 to 8 mT (Example 7) and 12 mT (Example 8), releasing property, resupplying property, agitating property and circulating property of the developing device were evaluated. Results are shown in a table 3.

TABLE 3

| | Releasing | Resupplying | Agitating | Circulating |
|---|---|---|---|---|
| | property | property | property | property |
| Example 7 | A | A | A | A |
| Example 8 | B | A | A | B |

In Example 8 in which the minimal value of the magnetic flux density in the normal direction between the removing pole N3 and the scooping pole N2 fell out of a range of 0 mT or more and 10 mT or less, releasing property and circulating property were slightly worse than those of Example 7 falling within the above range.

The technology may be embodied in other specific forms without departing from the spirit or essential characteristics thereof. The present embodiments are therefore to be considered in all respects as illustrative and not restrictive, the scope of the technology being indicated by the appended claims rather than by the foregoing description and all changes which come within the meaning and the range of equivalency of the claims are therefore intended to be embraced therein.

What is claimed is:

1. A developing device, comprising:
a developing roller having a cylindrical-shaped sleeve supported so as to be rotatable around an axis thereof and a magnet roller provided with a plurality of magnetic poles that are fixed in the cylindrical-shaped sleeve, the developing roller carrying a two-component developer including a toner and a carrier on a surface of the cylindrical-shaped sleeve to convey the two-component developer to a developing area facing a photoreceptor on which an electrostatic latent image is formed, the plurality of magnetic poles including a developing magnetic pole for supplying the toner to the photoreceptor in the developing area, and a removing pole disposed on a downstream side from the developing area in a rotational direction of the cylindrical-shaped sleeve, for removing the two-component developer residing on the surface of the cylindrical-shaped sleeve after the toner is supplied to the photoreceptor from the surface of the cylindrical-shaped sleeve;
a developer supplying member that is disposed vertically below the developing roller and supplies the two-component developer to the surface of the cylindrical-shaped sleeve on an upstream side from the developing area in the rotational direction of the cylindrical-shaped sleeve;
a collecting conveyance member that is disposed on the downstream side from the developing area in the rotational direction of the cylindrical-shaped sleeve and conveys the two-component developer removed from the surface of the cylindrical-shaped sleeve by the removing pole, the collecting conveyance member having a first rotational shaft section extending along a first axis parallel to a rotational axis of the cylindrical-shaped sleeve and a first spiral blade section attached in a spiral form to the first rotational shaft section, the collecting conveyance member conveying the two-component developer along the first axis by the first spiral blade section when the first rotational shaft section rotates around the first axis; and
a movement regulating member that is disposed on a downstream side from the developer collecting conveyance member in the rotational direction of the cylindrical-shaped sleeve and on an upstream side from the developer supplying member in the rotational direction of the cylindrical-shaped sleeve, and regulates movement of the two-component developer residing on the surface of the cylindrical-shaped sleeve,
an angle α formed by a first plane including a position at which a magnetic flux density in a normal direction by the removing pole becomes a maximal value on the surface of the cylindrical-shaped sleeve and the rotational axis of the cylindrical-shaped sleeve, and a second plane including the first axis of the first rotational shaft section and the rotational axis of the cylindrical-shaped sleeve being 20° or more and 40° or less.

2. The developing device of claim 1, wherein
the maximal value of the magnetic flux density in the normal direction by the removing pole is 30 mT or more and 50 mT or less.

3. The developing device of claim 1, wherein
the plurality of magnetic poles further include a scooping pole for scooping up the two-component developer to the surface of the cylindrical-shaped sleeve from the developer supplying member, and
a minimal value of the magnetic flux density in a normal direction between the removing pole and the scooping pole on the surface of the cylindrical-shaped sleeve is 0 mT or more and 10 mT or less.

4. The developing device of claim 2, wherein
the plurality of magnetic poles further include a scooping pole for scooping up the two-component developer to the surface of the cylindrical-shaped sleeve from the developer supplying member, and
a minimal value of the magnetic flux density in a normal direction between the removing pole and the scooping pole on the surface of the cylindrical-shaped sleeve is 0 mT or more and 10 mT or less.

5. The developing device of claim 1, wherein
the developer supplying member has a second rotational shaft section extending along a second axis parallel to the rotational axis of the cylindrical-shaped sleeve and a second spiral blade section attached in a spiral form to the second rotational shaft section, and conveys the two-component developer along the second axis by the second spiral blade section when the second rotational shaft section rotates around the second axis, and
the first rotational shaft section is disposed above the second rotational shaft section.

6. The developing device of claim 2, wherein
the developer supplying member has a second rotational shaft section extending along a second axis parallel to the rotational axis of the cylindrical-shaped sleeve and a second spiral blade section attached in a spiral form to the second rotational shaft section, and conveys the two-component developer along the second axis by the second spiral blade section when the second rotational shaft section rotates around the second axis, and
the first rotational shaft section is disposed above the second rotational shaft section.

7. The developing device of claim 3, wherein
the developer supplying member has a second rotational shaft section extending along a second axis parallel to the rotational axis of the cylindrical-shaped sleeve and a second spiral blade section attached in a spiral form to the second rotational shaft section, and conveys the two-component developer along the second axis by the second spiral blade section when the second rotational shaft section rotates around the second axis, and
the first rotational shaft section is disposed above the second rotational shaft section.

8. The developing device of claim 4, wherein
the developer supplying member has a second rotational shaft section extending along a second axis parallel to the rotational axis of the cylindrical-shaped sleeve and a second spiral blade section attached in a spiral form to the second rotational shaft section, and conveys the two-component developer along the second axis by the second spiral blade section when the second rotational shaft section rotates around the second axis, and
the first rotational shaft section is disposed above the second rotational shaft section.

9. An image forming apparatus comprising the developing device of claim 1.
